(19) United States
(12) Patent Application Publication
(10) Pub. No.: US 2020/0155389 A1
(43) Pub. Date: May 21, 2020

(54) Wheelchair Head Support

(71) Applicant: Mary Lee, Mesa, AZ (US)

(72) Inventor: Mary Lee, Mesa, AZ (US)

(21) Appl. No.: 16/354,742

(22) Filed: Mar. 15, 2019

Related U.S. Application Data
(60) Provisional application No. 62/768,280, filed on Nov. 16, 2018.

(51) Int. Cl. A61G 5/12; A61G 5/10

(52) U.S. Cl. CPC A61G 5/121; A61G 5/1067; A61G 5/1091

(57) ABSTRACT

A wheelchair head support. The wheelchair head support may have a first and a second support pole connected to a wheelchair in a vertical position. A flexible panel may be connected to the support poles. The panel may further include an attached pillow which adds extra support. The wheelchair head support may attach to the wheel chair using a set of friction connectors or with a set of clamps or any other suitable fasteners.

### CROSS REFERENCE TO RELATED APPLICATIONS

This application claims the benefit of U.S. Provisional Application No. 62/768,280 filed on Nov. 16, 2018. The above identified patent application is herein incorporated by reference in its entirety to provide continuity of disclosure.

### BACKGROUND OF THE INVENTION

The present invention relates to wheelchair headrests. More particularly, the present invention provides an article for supporting an individual's head and back when using a wheelchair.

Many people find themselves in need of a wheelchair either as a result of injury or old age. In a traditional wheelchair, an individual's upper back and neck are typically left unsupported. This is the result of the wheelchair back not being sufficiently tall. This means that an individual must keep their head balanced and in an upright position. This can cause strain to a person's neck. Further, if an individual is injured it can be even harder to keep their head in an upright position. This can lead to a further injury or a prolonged recovery time.

Consequently, there is a need in for an improvement in the art of wheelchairs. The present invention substantially diverges in design elements from the known art while at the same time solves a problem many people face using a wheelchair. In this regard the present invention substantially fulfills these needs.

### SUMMARY OF THE INVENTION

The present invention provides for a wheelchair head support wherein the same can be utilized for providing convenience for the user when sitting in a wheelchair.

The present system comprises a first and a second support pole connected to a wheelchair in a vertical position. A flexible panel may be connected to the support poles. The panel may further include an attached pillow which adds extra support. The wheelchair head support may attach to the wheel chair using a set of friction connectors or with a set of clamps or with any other suitable fasteners.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the wheelchair head support in use with a cushion attachment.

FIG. 1B shows a perspective view of an embodiment of the wheelchair head support in use.

FIG. 2A shows a front view of an embodiment of the wheelchair head support attached to a wheel chair with clamps.

FIG. 2B shows a rear view of an embodiment of the wheelchair head support attached to a wheel chair with clamps.

FIG. 3A shows a front view of an embodiment of the wheelchair head support with an additional cushion attached.

FIG. 3B shows a rear view of an embodiment of the wheelchair head support with an additional cushion attached.

FIG. 4A shows a front view of an embodiment of the wheelchair head support attached using male and female connectors.

FIG. 4B shows a rear view of an embodiment of the wheelchair head support attached using male and female connectors.

FIG. 5 shows a perspective view of an embodiment of the wheelchair head support attached to a wheel chair as it is being folded.

### DETAILED DESCRIPTION OF THE INVENTION

Reference is made herein to the attached drawings. Like reference numerals are used throughout the drawings to depict like or similar elements of the wheelchair head support. For the purposes of presenting a brief and clear description of the present invention, a preferred embodiment will be discussed as used for the wheelchair head support. The figures are intended for representative purposes only and should not be considered to be limiting in any respect.

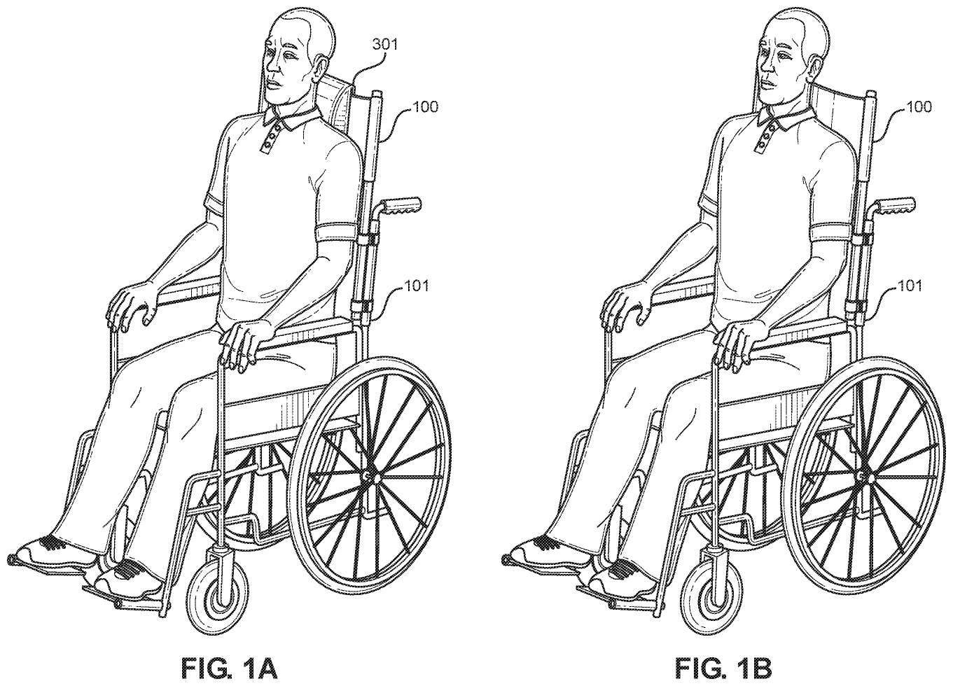

Referring now to FIG. 1A and FIG. 1B, there are shown perspective views of an embodiment of the wheelchair head support in use. FIG. 1A specifically shows an individual using a wheelchair 101 and a wheelchair head support 100. The wheelchair head support 100 may be located at such a height where the individual's head is supported by the wheelchair head support 100 in a comfortable position. In another embodiment, the wheelchair head support 100 may further include cushion attachment 301 to give further support to the head.

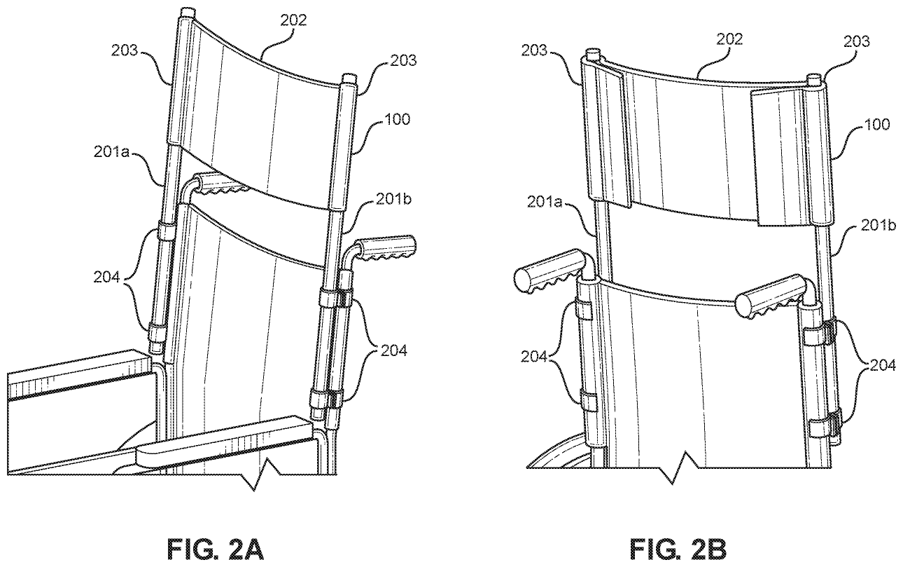

Referring now to FIG. 2A and FIG. 2B, there is shown a front view and a rear view of an embodiment of the wheelchair head support attached to a wheel chair with clamps. The wheelchair head support 100 includes a pair of support poles 201a and 201b. A panel member 202 is connected to the support poles 201a, 201b. In one embodiment, the panel member 202 is composed of a flexible cloth material. The panel member 202 has sleeves 203 located at opposite ends of the panel member 202. The sleeves 203 slide directly over the support poles 201a, 201b in order to secure the panel member 202 to the wheelchair 101. In other embodiments, the panel member 202 may be tied to the support poles 201a, 201b using a cord, a hook and look connector, or any other suitable fastener.

In one embodiment, the support poles 201a, 201b are connected to the wheelchair using clamps 204. In one embodiment, the clamps 204 are pipe clamps. In another embodiment the clamps 204 include two connectors. One connector connects to the wheelchair and the second connector connects to a support pole 201a, 201b. In this embodiment, the wheelchair head support 100 is capable of staying connected to the wheelchair even if the second connection is loosened to release the wheelchair head support 100.

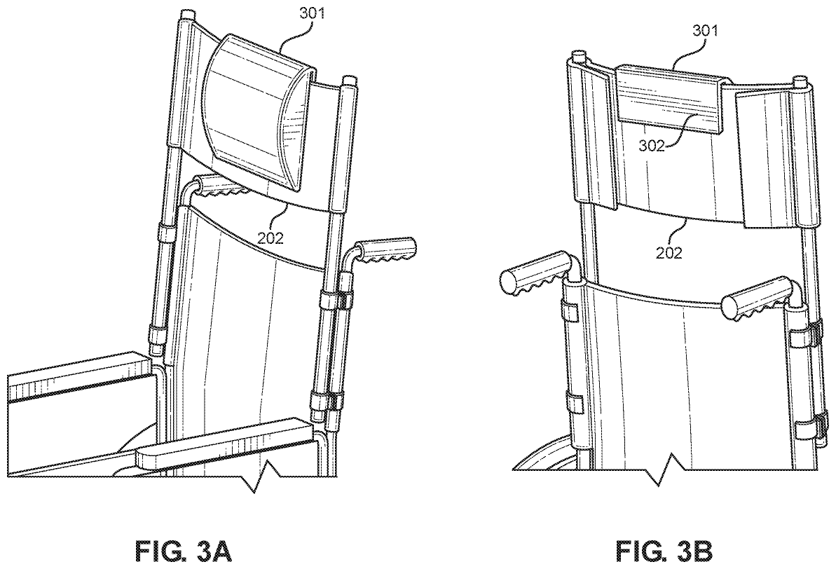

Referring now to FIG. 3A and FIG. 3B, there is shown a front and a rear view of an embodiment of the wheelchair head support with an additional cushion attached. In the shown embodiment, the cushion 301 is attached to the panel member 202 using a hook attachment 302. In the shown embodiment, the hook attachment 302 comprises a solid hook that extends across a width of the cushion 301 and is long enough to hold the cushion 301 in a specific place against the panel member 202. In a second embodiment, the cushion 301 attaches to the panel 202 using a hook and loop connector. In this embodiment, one part of the hook and loop connector is placed on the cushion 301. The second part of the hook and loop connector is placed on the panel member. This embodiment will allow the cushion to be moved around the panel and to have a flexibility.

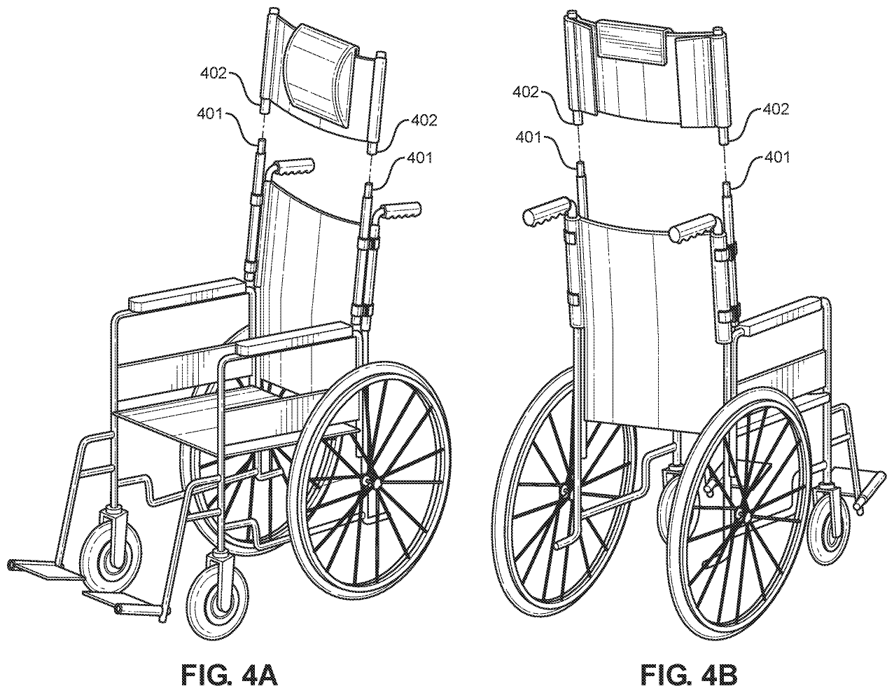

Referring now to FIG. 4A and FIG. 4B, there is shown a front and rear view of an embodiment of the wheelchair head support attached using male and female connectors. In the shown embodiment, there are male connectors 401 attached to the wheel chair. The male connectors 401 are attached via clamps as described above, or may integrally formed with the wheelchair. In one embodiment, the male connectors 401 are welded to the wheelchair. In another embodiment, the male connectors are screwed to the wheelchair. In the shown embodiment, the support poles include a female end connector 402. This will allow the support poles to be attached to the wheelchair by placing the female connectors on the male connectors. The support poles are held in place via friction. In a different embodiment, the female connectors 402 may be attached to the wheelchair and the support poles include the male connector 401.

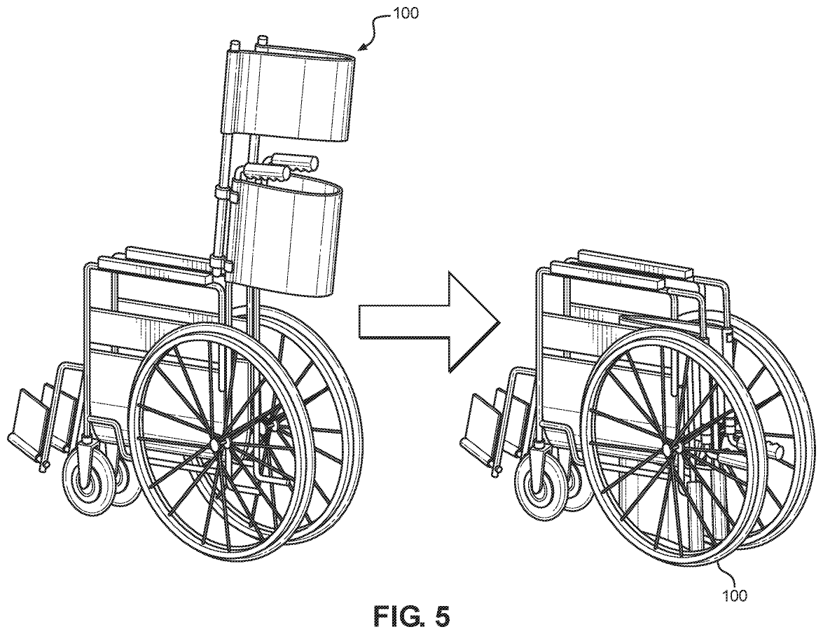

Referring now to FIG. 5, there is shown a perspective view of an embodiment of the wheelchair head support attached to a wheel chair as it is being folded. In the shown embodiment, the wheelchair is able to be folded into a storage position. In this embodiment, the wheelchair head support 100 can be a height that will allow the wheelchair to be folded into a storage position with the wheelchair head support 100 attached. In another embodiment, the wheelchair head support 100 is adjustable in height. The wheelchair head support 100 may be able to be slid up and down. This adjustment can support individuals of different heights and can allow the wheelchair to be folded.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wheelchair head support, comprising:
a first and a second support pole connected to a wheelchair in a vertical position;
a panel connected to the first and the second support pole;
wherein the panel is disposed between the first support pole and the second support pole above a back panel of the wheelchair.

2) The wheelchair head support of claim 1, further comprising: a raised portion located on a front side of the panel.

3) The wheelchair head support of claim 2, wherein the raised portion is a removably attached pillow.

4) The wheelchair head support of claim 1, further comprising a ring clamp connector configured to attach the first support pole and the second support pole to the wheelchair.

5) The wheelchair head support of claim 1, wherein the panel is composed of a flexible fabric material.

6) The wheelchair head support of claim 1, further comprising: a wheelchair with a pair of vertical male members;
wherein the first support pole and the second support pole comprise female connectors located therein;
wherein the female connectors of the first support pole and the second support pole are configured to attach to the male connectors.

7) The wheelchair head support of claim 1, wherein the panel comprises a sleeve at each end in order to attach to the support poles.
